(19) United States
(12) Patent Application Publication
(10) Pub. No.: US 2022/0405108 A1
(43) Pub. Date: Dec. 22, 2022

(54) System and Method for GUI Development and Deployment in a Real Time System

(71) Applicants: Robert Bosch GmbH, Stuttart (DE); Robert Bosch Engineering and Business Solutions Private Limited, Bangalore, Kamataka (IN)

(72) Inventors: Jessayen Raja, Coimbatore, Tamil Nadu (IN); Kannan Karthikeyan, Coimbatore, Tamil Nadu (IN); Chinnappan Manikandan, Coimbatore, Tamil Nadu (IN)

(21) Appl. No.: 17/753,306

(22) PCT Filed: Jul. 15, 2020
(86) PCT No.: PCT/EP2020/070028

§ 371 Date: Feb. 26, 2022

(30) Foreign Application Priority Data
Jul. 25, 2019 (IN) 201941030074

(51) Int. Cl. G06F 9/451; G06F 8/38

(52) U.S. Cl. CPC G06F 9/451; G06F 8/38

(57) ABSTRACT

A system is for development and deployment of a dynamically editable graphical user interface on a connected real-time device. The system includes an input module configured to receive and process a plurality of graphical user interface inputs, and a GUI specification generator configured to parse the processed graphical user interface inputs and generate machine understandable graphical user interface specification from the plurality of graphical user interface inputs. The system also includes a GUI configurator interactively connected to the GUI specification generator and configured to inject performance load balancing parameters and configuration data along with the graphical user interface configuration data. The system further includes a real-time module configured to automatically deploy the machine executable graphical user interface specification on the connected real time system and to edit the graphical user interface inputs in real time while dynamically optimizing the GUI performance using the load balancing parameters.

### FIELD OF THE INVENTION

Present invention is related to a system and a method for development and deployment of flexible, dynamically editable and load-balanced GUI in a connected real time system.

### BACKGROUND OF THE INVENTION

Typically, the UX designers create all digital assets on their PC/Mac which includes screen flows and contents (images and texts) using digital content creation software tools like Sketch, Photoshop, etc. However, even after creating the complete visualization they need to create written and diagrammatic specification/requirements documents so that it could be converted into a software that can be executed on a target device with appropriate performance and load balancing. This involves a lot of effort to understand complex GUI behaviors using the specification documentation in order to convert the specification to target hardware specific visualization and performance. This results in a lot of iterations, delays, visual defects and performance defects.

Presently most of the software products are capable of performing basic image and text import from GUI designs and generate GUI software for these basic screens. However, these products do not generate and provide live editing of the GUI contents in real time. The products are also not capable of monitoring the computing resource load on the connected real time system and generate GUI software that is capable of balancing the computing resource load.

Moreover, there are a few software products are available to convert digital assets like images and text from GUI designs to partial GUI software components or basic HTML pages or GUI prototypes. However these software need to be ported to the target hardware manually and later need to be tuned for performance by developers. Besides, this process needs to be repeated every time there is a change in the GUI screen flows or screen visualization or when the input sources change.

According to an US application numbered U.S. Pat. No. 6,496,202B, a method and apparatus for generating a graphical user interface. This patent provides a design using which a GUI can change its visualization depending on how the user interacts with the application in the field. For example, when a user clicks a button, a part of the screen/fragment/control can be switched off and a new screen/fragment/control can be added automatically. However someone needs to explicitly decide what the behavior shall be when the event happens and once this is specified the design helps in generating the GUI that satisfies the new requirements. However, the disclosed system do not allow the GUI behaviors or specification itself to be edited in real time on the connected real time device. It also does not optimize the GUI based on the performance and load on the real time system.

Hence, there is a need of a solution to capture the inputs from the UX designers from various mediums, tools and formats and then generate machine understandable GUI specification that is capable of being directly interpreted and executed on the connected real time system without any manual involvement.

### BRIEF DESCRIPTION OF THE ACCOMPANYING DRAWING

Different modes of the invention is disclosed in detail in the description and illustrated in the accompanying drawings:

FIG. 1 is a block diagram illustrating a system for deployment of dynamically editable GUI on a connected real-time device, according to the aspects of the present invention; and

FIG. 2 is an example process for deployment of dynamically editable GUI on a connected real-time device using the system of FIG. 1, according to the aspects of the present technique.

### DETAILED DESCRIPTION OF THE EMBODIMENTS

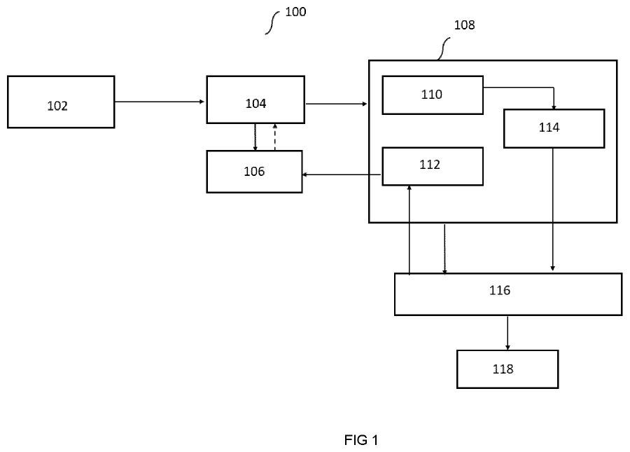

FIG. 1 illustrates overall structure and components involved in a system 100, in which example embodiments of the present invention may be deployed. The system 100 is adapted to automatically deploy the machine executable graphical user interface (hereinafter “GUI”) specifications on a connected real time device. The system 100 may be deployed in various environments. For example, the system 100 can be deployed on a cloud or a server which can then service the requests/inputs from several clients. The system 100 includes an input module 102, a GUI specification generator 104, a GUI configurator 106, a real-time module 108, a rendering module 116 and output module 118. Each component is described in further detail below.

The input module 102 is configured to receive a plurality of GUI inputs from a user, herein UX designer. In one embodiment, the plurality of GUI inputs may be captured from several mediums such as images via camera, screenshots, frame-grabber, video, audio, digital content creation tools like Photoshop, Sketch, and the like. In this embodiment, the GUI inputs may be live feed or recorded playback.

The input module 102 is further configured to convert the plurality of GUI inputs to digital formats, data and meta-data which are relevant for GUI development. In addition, the plurality of GUI inputs are processed to identify the building blocks of a GUI such as GUI screen flows, GUI layouts, GUI contents and the like. In one example, pattern matching, image comparisons, context aware content recognition, machine learning techniques may be used to perform the identification of the building blocks of the GUI. However, a variety of other identification techniques may be envisaged.

The GUI Specification generator 104 is configured to parse the processed GUI inputs and generate machine understandable graphical user interface specification from the plurality of graphical user interface inputs. In one embodiment, the processed GUI inputs is the digital GUI data and meta-data. The GUI Specification generator 104 is further configured to generate machine understandable specifications for GUI flows, screens and contents. The generated GUI specifications are then uploaded onto a storage module 110 of the real-time module 108. Furthermore, after identifying the building blocks of the GUI, the blocks are stored digitally with appropriate meta-data which is used to describe the GUI. The digital GUI data along with appropriate meta-data is then passed onto the GUI specification generator 104, which can further act on the plurality of GUI inputs. The GUI specification generator 104 may be deployed in various environments. For example, it can be deployed on a cloud or a server which can then service the requests/inputs from several clients.

The GUI Configurator 106 is configured to inject performance load balancing parameters and configuration data along with the GUI configuration data. The GUI Configurator 106 is further configured to parse the digital asset data and meta-data related to the GUI. In one embodiment, after the parsing is done, the GUI configurator 106 is further configured to enable the UX designer/user to edit the GUI flows, layouts and contents in the connected real time system and see the result on an output module 118 in real time.

In an alternate embodiment, the GUI configurator 106 is integrated to a content management system (CMS) server. Further, the GUI configurator 106 configured to receive several dynamic updates from a content management system (CMS) server for the latest digital assets.

The real-time module 108 configured to automatically deploy the machine executable GUI specification on the connected real time system and edit the GUI inputs in real time. In an embodiment the real-time module 108 may be deployed in various environments. For example, the real-time module 108 can be deployed over, websites, desktop, PC's, MAC or the like. The real-time module 108 includes a storage module 110, load balancer 112 and a loading engine 114. Each component is described in further detail below.

The storage module 110 is configured to store the machine understandable GUI specification, generated by the GUI specification generator 104. In one embodiment, the machine understandable GUI specification includes GUI screen flows, layouts and contents. The storage module 100 is configured to store the machine understandable GUI specification in the form of XMLs, binaries, configuration parameters, tables, OpenGL/WebGL/Vulkan/OpenVG/2D graphics lib invocations, and the like.

The load balancer 112 is configured to collect real time computing resource loads from the connected real time system. The load balancer 112 runs on the real time system and continuously keeps monitoring the load.

The loading engine 114 is configured to ensure that the graphical user interface specification is loaded from the storage module (110) and forwarded to a rendering module (116). The rendering module 116 is configured to execute the generated machine understandable GUI specification on a real time system. In one embodiment, when the GUI specifications such as screen flow, layouts and contents are executed on the rendering module 116, the load is monitored by the load balancer 112 and sent to the GUI Configurator 106 in real time as a load balancing configuration. The GUI

Configurator 106 uses the load balancing configuration to optimize the GUI configuration Flow, layout and contents. In one example, the computing resource load on the connected real time system is monitored and its usage is evaluated in real time to derive the optimal load balancing strategy.

In another embodiment, the GUI Configurator 106 is interactively connected with the load balancer 112 on the connected real time device. Based on the load balancing configuration data received from the load balancer 112, the GUI

Configurator 106 injects performance load balancing parameters and configuration data along with the GUI flow, layouts and content configuration data. Further, this data flows to the GUI Specification generator 104 which uses the configuration data to generate a load balanced application. In one embodiment, This load balanced GUI configuration is then sent to the GUI Specification generator which in turn generates the machine understandable GUI specification that is then stored on the storage module 110 of the connected real time system.

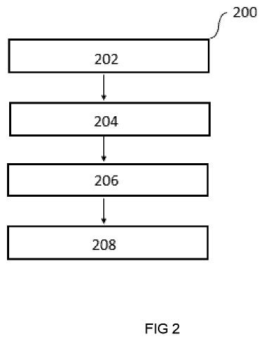

FIG. 2 is an example process 200 for deployment of dynamically editable GUI on a connected real-time device using the system 100 of FIG. 1, according to the aspects of the present technique.

At step 202, a plurality of GUI inputs are received, to identify the building blocks of the graphical user interface. In an embodiment, the plurality of GUI inputs may be captured from several mediums such as images via camera, screenshots, frame-grabber, video, audio, digital content creation tools like Photoshop, Sketch, and the like. In some embodiments, the GUI inputs are accessed from other locations such as from an offline image repository, cloud storage and so forth. In an embodiment, the GUI inputs may be live feed or recorded playback.

At step 204, the plurality of GUI inputs are converted into digital format for use by the graphical user interface. The plurality of GUI inputs are processed to identify the building blocks of a GUI such as GUI screen flows, GUI layouts, GUI contents and the like. In one example, pattern matching, image comparisons, context aware content recognition, machine learning techniques may be used to perform the identification of the building blocks of the GUI. However, a variety of other identification techniques may be envisaged.

At step 206, the digital graphical user interface inputs are parsed and machine understandable graphical user interface specification is generated from the plurality of GUI inputs. At step 208, the graphical user interface behavior is edited in real time, on the connected real time system. After the parsing is done, the GUI configurator 106 of FIG. 1 is configured to enable the UX designer/user to edit the GUI flows, layouts and contents in the connected real time system and see the result on an output module 118 in real time.

Portions of the example embodiments and corresponding detailed description may be presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

The system(s)/apparatus(es), described herein, may be realized by hardware elements, software elements and/or combinations thereof. For example, the devices and components illustrated in the example embodiments of inventive concepts may be implemented in one or more general-use computers or special-purpose computers, such as a processor, a controller, an arithmetic logic unit (ALU), a digital signal processor, a microcomputer, a field programmable array (FPA), a programmable logic unit (PLU), a microprocessor or any device which may execute instructions and respond. A central processing unit may implement an operating system (OS) or one or more software applications running on the OS. Further, the processing unit may access, store, manipulate, process and generate data in response to execution of software. It will be understood by those skilled in the art that although a single processing unit may be illustrated for convenience of understanding, the processing unit may include a plurality of processing elements and/or a plurality of types of processing elements. For example, the central processing unit may include a plurality of processors or one processor and one controller. Also, the processing unit may have a different processing configuration, such as a parallel processor.

The methods according to the above-described example embodiments of the inventive concept may be implemented with program instructions which may be executed by computer or processor and may be recorded in computer-readable media. The media may also include, alone or in combination with the program instructions, data files, data structures, and the like. The program instructions recorded in the media may be designed and configured especially for the example embodiments of the inventive concept or be known and available to those skilled in computer software. Computer-readable media include magnetic media such as hard disks, floppy disks, and magnetic tape; optical media such as compact disc-read only memory (CD-ROM) disks and digital versatile discs (DVDs); magneto-optical media; and hardware devices that are specially configured to store and perform program instructions, such as read-only memory (ROM), random access memory (RAM), flash memory, and the like. Program instructions include both machine codes, such as produced by a compiler, and higher level codes that may be executed by the computer using an interpreter. The described hardware devices may be configured to execute one or more software modules to perform the operations of the above-described example embodiments of the inventive concept, or vice versa.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” of “displaying” or the like, refer to the action and processes of a computer system, or similar electronic computing device/hardware, that manipulates and transforms data represented as physical, electronic quantities within the computer system's registers and memories into other data similarly represented as physical quantities within the computer system memories or registers or other such information storage, transmission or display devices.

It should be understood that embodiments explained in the description above are only illustrative and do not limit the scope of this invention. Many such embodiments and other modifications and changes in the embodiment explained in the description are envisaged. The scope of the invention is only limited by the scope of the claims.

1. A system for development and deployment of a dynamically editable graphical user interface (GUI) on a connected real-time device, the system comprising:
an input module configured to receive and process a plurality of graphical user interface inputs;
a GUI specification generator configured to parse the processed plurality of graphical user interface inputs and to generate a machine executable graphical user interface specification from the processed plurality of graphical user interface inputs;
a GUI configurator configured to inject performance load balancing parameters configuration data, and graphical user interface configuration data; and
a real-time module configured to automatically deploy the machine executable graphical user interface specification on the connected real-time device and to edit the plurality of graphical user interface inputs in real time, wherein the real-time module comprises:
a storage module configured to store the machine executable understandable graphical user interface specification; and
a load balancer configured to collect real-time computing resource loads from the connected real-time device.

2. The system as claimed in claim 1, further comprising:
a rendering module configured to execute the generated machine executable graphical user interface specification.

3. The system as claimed in claim 2, wherein the real-time module further comprises:
a loading engine configured to load the machine executable graphical user interface specification from the storage module and to forward the machine executable graphical user interface specification to the rendering module.

4. The system as claimed in claim 1, wherein the plurality of graphical user interface inputs are processed to identify building blocks of a graphical user interface such as graphical user interface screen flows, graphical user interface layouts, and graphical user interface contents.

5. The system as claimed in claim 4, wherein the GUI specification generator is further configured (i) to parse the graphical user interface configuration data and meta-data, and (ii) to generate a standardized specification for the graphical user interface flows, layouts, and contents.

6. The system as claimed in claim 2, wherein the GUI configurator is further configured (i) to interact with the load balancer on the real-time device, and (ii) to adapt the graphical user interface configuration data in order to better utilize the rendering module on the connected real-time device.

7. The system as claimed in claim 1, wherein the real-time module is further configured to edit graphical user interface requirements and behaviors directly on the connected real-time device.

8. The system as claimed in claim 1, wherein the real-time module is further configured to edit graphical user interface requirements and graphical user interface behaviors directly on the connected real-time device, by dynamically modifying the machine executable graphical user interface specification.

9. The system as claimed in claim 1, wherein the system is further configured to optimize the generated machine executable graphical user interface specification using load balancing data derived out of monitoring the computing resource loads on the connected real-time device.

10. A method of deployment of a dynamically editable graphical user interface on a connected real-time device, the method comprising:
receiving a plurality of graphical user interface inputs, to identify building blocks of a graphical user interface;
converting the plurality of graphical user interface inputs into digital format for use by the graphical user interface;
parsing the digital format graphical user interface inputs and generating a machine executable graphical user interface specification from the plurality of graphical user interface inputs; and
real-time editing a behavior of the graphical user interface on the connected real-time device.
